(19) United States
(12) Patent Application Publication
(10) Pub. No.: US 2018/0221827 A1
(43) Pub. Date: Aug. 9, 2018

(54) METHOD AND APPARATUS FOR MITIGATING BIO FOULING IN REVERSE OSMOSIS MEMBRANES

(71) Applicant: Aquatech International, LLC, Canonsburg, PA (US)

(72) Inventor: Ravi CHIDAMBARAN, Canonsburg, PA (US)

(21) Appl. No.: 15/751,780

(22) PCT Filed: Aug. 10, 2016
(86) PCT No.: PCT/US2016/046343

§ 371 Date: Feb. 9, 2018

Related U.S. Application Data
(60) Provisional application No. 62/203,317, filed on Aug. 10, 2015.

(51) Int. Cl. B01D 65/08; B01D 61/02; B01D 61/14; B01D 61/04; B01D 61/58; C02F 1/44; C02F 1/469

(52) U.S. Cl. CPC B01D 65/08; B01D 61/025; B01D 61/145; B01D 61/04; B01D 61/58; C02F 2101/30; C02F 1/444; C02F 1/469; B01D 2311/04; B01D 2311/2603; C02F 1/441

(57) ABSTRACT

A method and apparatus for reduction of biofouling on reverse osmosis membranes is provided. One embodiment provides a charged filter surrounding a cathode that is, in turn, surrounded by an anode. A plurality of these charged filters may be included in a larger filtration system that may be included in a typical reverse osmosis system.

### CROSS-REFERENCE TO RELATED APPLICATIONS

This application claims priority to U.S. Provisional Patent App. No. 62/203,317, filed on Aug. 10, 2015. That application is incorporated by reference herein.

### BACKGROUND OF THE INVENTION

### Field of the Invention

Embodiments relate to methods and apparatus for reduction of fouling on reverse osmosis membranes.

### Background of the Related Art

Bio fouling remains one of the main reasons for fouling on reverse osmosis membrane during treatment of sea water or waste water. Many pretreatment and disinfection methods have been tried but they have not been effective in mitigating this problem. Many approaches, like chlorination and de-chlorination, have on the contrary made the problem worse. This is because the presence of residual bacteria and highly oxidized organic products that are present after the oxidation still increase the bio fouling potential of the water.

Ultrafiltration provides 6 log reduction of bacteria and partially removes some organic matter, but the residual organics and bacteria still result in serious bio fouling. In particular, transparent exopolymer particles (“TEPS”) are known to pass the ultrafiltration membrane and cause primary fouling. This, in turn, causes subsequent secondary fouling due to the residual bacteria. This results in irreversible flux loss through the membranes and slowly increases the differential pressure (DP) in spite of frequent cleaning.

### BRIEF DESCRIPTION OF THE INVENTION

It would be beneficial to mitigate bio fouling in the RO membranes, which happens in the seawater and waste water based desalination plants. Embodiments as reported herein address a root cause of bio fouling by treating both organics and the bacteria that are responsible for bio fouling. The invention is based on an electro chemical method accomplished through a filtration and electrode assembly device.

The filtration device works on a surface charge mechanism by adsorbing charged particles like TEPs downstream of the UF, which are carried through UF in the permeate. The electrode device includes a cathode and an anode and de-activates the bacteria under the influence of a mild DC current. This keeps the surface of the filter clean by regenerating it and removing the adsorbed organics and allowing it to drain. During regeneration the polarity of the electrodes is reversed. This provides ideal conditions for regeneration because the conditions are like almost clean conditions. This also increases the life of the filter by preventing increase in the filter DP. Mechanically the filter and the electrodes are encapsulated in a plastic or a metal housing. The filter elements can be pulled out for replacement.

Embodiments may provide a filter system including a housing having an interior and an exterior, a filter cartridge on the interior of the housing, said filter cartridge comprising a cylindrical filter material, said filter material surrounding a cathode, and said filter material surrounded by an anode plate; wherein the housing comprises an inlet, an outlet, a drain, and a vent. In certain embodiments the filter system includes multiple filter cartridges on the interior of the housing.

In further embodiments the filter system includes multiple filter cartridges depending on the design flow. In further embodiments the filter cartridge is at least 30″ in length. In some embodiments the filter cartridge is between 30″-40″ in length.

In some embodiments there are more than one filter cartridge, and they operate in parallel. Embodiments may handle a wide range of flow rates. For example, they may handle flow rates of up to 1000 m³/hour.

In some embodiments the cathode is a cylindrical rod. In some embodiments the filter is positively charged filtration media. In other embodiments it is negatively charged filtration media. Embodiments may include a power supply in a circuit with the cathode and the anode. That power supply may be mounted directly on the filtration system housing. The housing may be constructed, for example, of a material selected from the group consisting of fiber reinforced plastic, rubber-lined carbon steel, and stainless steel.

In embodiments the filter system has a water flow rate capacity, and wherein the water flow rate capacity increases proportionately to the number of filter cartridges in the filter system.

Embodiments may further provide methods for reducing biofouling on a reverse osmosis membrane, including treating water comprising biofoulants with an ultrafiltration membrane; and after treating the water with an ultrafiltration membrane, treating the water with a charged filter system. In such embodiments the charged filter system may include a housing having an interior and an exterior, at least one filter cartridge on the interior of the housing, said filter cartridge comprising a cylindrical filter material, said filter material surrounding a cathode, and said filter material surrounded by an anode plate, wherein the housing comprises an inlet, an outlet, a drain, and a vent; and a power supply in communication with the cathode and the anode.

In some embodiments the water to be purified includes an amount of polysaccharides, and wherein after treatment with the charged filter system the amount of polysaccharides is reduced. In further embodiments the water to be purified includes an amount of bacteria, and wherein after treatment with the charged filter system the amount of bacteria is reduced without using any oxidants. In some embodiments there is no difference in oxidation reduction potential (ORP) value of water across the filter system.

Further embodiments include regenerating at least one filter in the charged filter system in-situ by changing polarity of the charge and draining previously adsorbed material.

### BRIEF DESCRIPTION OF THE FIGURES

FIG. 1 shows an electro-biofoulant removal filter as reported herein in embodiments of the invention.

FIG. 2 shows a top view of a multi-filter assembly of an electro-biofoulant removal filter for high flows.

FIG. 3 shows flow diagrams of electro-biofoulant removal filters in operation.

FIG. 4 shows an FTIR curve of a filter's deposited material showing —OH (hydroxyl) and —COOH (carboxyl) peaks indicating the presence of TEP in the tested material.

FIG. 5 shows an Alcian Blue test for polysaccharides in an electro-biofoulant removal filter of an embodiment as reported herein.

### DETAILED DESCRIPTION OF THE INVENTION

I. Methods for Reducing Bio Fouling

Embodiments provide a process and equipment solution for bio fouling problem which is experienced in surface water and waste water based reverse osmosis plants. Typically this bio fouling results from the inability of the pretreatment process to adequately address this problem. Certain organics, which possess bio-fouling potential even pass through ultrafiltration membranes that provide 6-7 log bacteria reduction. But because of the carryover of both bacteria and organics (which may provide a food source for the bacteria), bio fouling takes place in the RO membrane.

RO membranes reject both bacteria and organics. The fouling primarily starts due to organics on the membrane surface. These organics become feed for bacteria and result in their exponential growth of bacteria. This initiates complex fouling. This further results in tertiary fouling due to the precipitation of inorganics like silica, heavy metals, hardness etc. This form of fouling results in significant pressure drop, does not respond to chemical cleaning, and becomes irreversible over a period of time. Eventually the membranes have to be replaced.

In sea water reverse osmosis plants, in spite of having UF pretreatment, contaminants like TEPs (Transparent Exo-polymer substances) pass through UF membranes. Combined with the presence of bacteria, these TEPs cause bio fouling on the RO membranes, as described above, and result in frequent membrane cleaning and eventual replacement. When the system is operated with continuously increasing differential pressure there is an increasing trend in energy consumption and operational costs.

Embodiments provide a solution to minimize or eliminate the bio fouling caused by naturally occurring organics and bacteria. The filter is made of a blend of organic and inert inorganic material, which includes a charge. The charge is caused by incorporating a anionic or cationic functional group into the filter, either by a chemical reaction or by incorporating ion exchange resin materials. The filter, with its charged surface, adsorbs organics. The filter works in presence of electrodes under the influence of DC electric current. The electrical field helps in keeping the adsorbtion bonding between the filter and the organics if any, labile and loose during the service cycle.

During the service cycle the DC voltage has a positive charge around the filter and a negative charge inside the filter. The polarity is reversed for regeneration for few seconds, when the electrode outside the filter becomes negative and inside the filter becomes positive. At this time the voltage is also increased to increase the current, and the drain is opened which cleans the filter and reduces the dP across the filter. Due to this the life of the filter is extended and the differential pressure remains less than 15 PSI and most between 5-10 psi.

As the water is coming out of ultrafiltration pretreatment, most of the suspended solids and colloidal material is filtered by ultrafiltration membrane. Therefore the downstream filter does not need to remove any suspended or colloidal particles. If the ultrafiltration membrane is not present upstream, most of the suspended and colloidal particles will be removed by the down stream filter and it will be quickly be used and the differential pressure will mount quickly. Also its surface charge will be fully blocked by the debris and the same will not be effective to remove any organics in water.

This filter also deactivates bacteria by damaging and rupturing the walls of its cells. The breeding of bacteria is stopped without using any external oxidants, which also create potent food for the bacteria that may survive the oxidation process. In this case there is no production of oxidizing material, as evidenced by the fact that ORP values measured at the inlet and outlet remain the same and by the fact that there is no increase of ORP across the filter.

We have further noted that if the filter operates without any voltage the increase of dp is very rapid, and we can see bio fouling on the filter itself as it turns blackish brown within few days of operation and starts smelling bad. Whereas under the influence of the electric voltage the bio-fouling of filter is stopped, the filter removes bio foulants very efficiently. This filter can be regenerated in place just by changing the polarity to get a longer life of few months and prevents any down stream bio fouling of the reverse osmosis membranes.

After several days of service in sea water down stream of an ultrafiltration system the filter units may be removed for replacement. A brown deposit or coating is seen on the filter surface. Such coating was predominantly seen where the regeneration was not possible because of lack of access. The brown deposits were scraped off and taken for FTIR analysis. FTIR showed peaks typically representing —OH (hydroxyl) and —COOH (carboxyl) groups, which are normally present in TEPs, which are polysaccharide materials found in sea waters.

This material was further subject to Alcian blue testing side by side with a standard xanthan gum. The feed water, which contained polysaccharides, and the drain water, which contained most of the removed polysaccharides during regeneration, showed maximum absorbance of Alcian blue and lower concentration in the filtered water of these waters through 0.2 micron filter. The filter paper in this cases got highest concentration of stain. The treated water showed very little coloration in the water sample and staining on the filter paper. The colorimetric analysis showed more than 90% reduction of polysaccharides through the bio foulant removal filter.

II. Apparatus for Reducing Bio Fouling

Filter material useful in embodiments of the invention is available as flat sheet, spiral wound material or in the form of cartridges. The filters can be made with anionic material or cationic material depending on the composition of organic contaminants in the feed water.

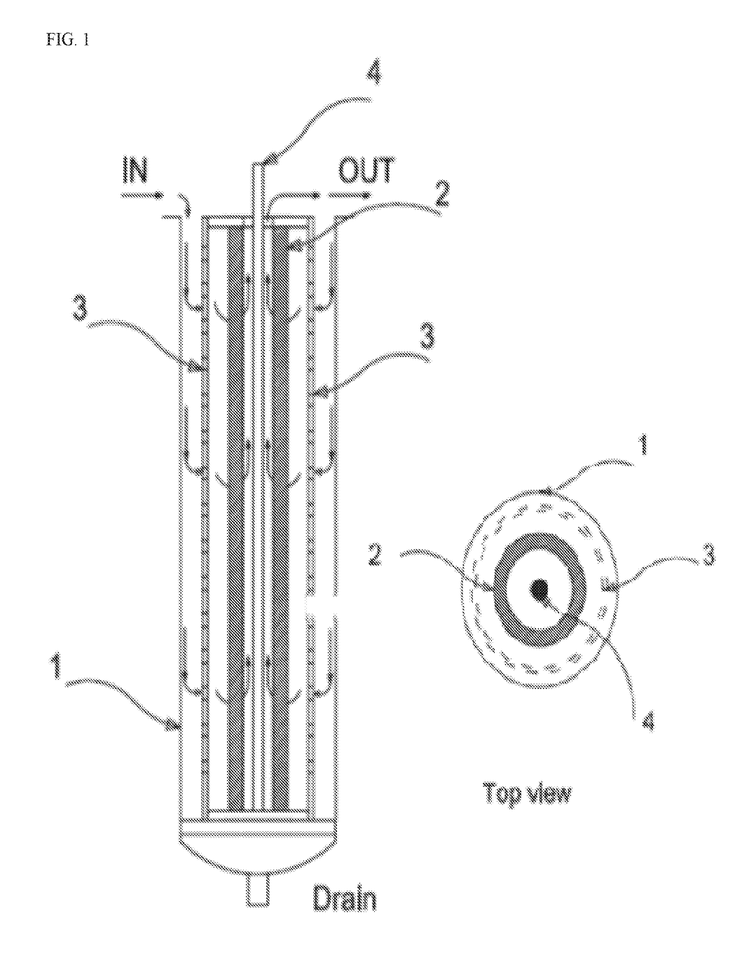

One of the embodiments of the filter construction has been detailed in FIG. 1. In this embodiment the filter has been constructed from positively charged cartridges. The filter is placed in a housing, which is designed to withstand pressure. The housing 1 can be designed for any pressure but typically between 100-150 psi design pressure, which works well for filter at the outlet of ultrafiltration system. The filter typically has an inlet, outlet, drain and vent nozzles.

In a single element filter the cartridge element 2 sits at the center. The filter is fitted and sealed with the help of O-rings and gaskets such that the feed and filtered water streams can be kept separate without any mixing. The filter is surrounded by an anode plate 3, which is made of a perforated material. Typically this material is 1-6 mm thick, preferably 2-3 mm thick. The anode material can be stainless steel material, preferably SS316 grade. Titanium may also be useful, particularly for water containing high levels of chloride, like seawater. Depending on the analysis of water and the pH different grades of anode material can be selected from, for example, different grades of stainless steel, titanium, tantalum or Hastelloy® brand alloys.

The cathode 4 is normally a rod that sits inside the cartridge. Typically it is a stainless steel material. It is also possible to make the cathode out of studs that are normally used to keep the cartridge bolted in place or something that is used to enclose the housing.

The electrodes are connected with a Direct Current (DC) power supply. Typically an ammeter and voltmeter are part of the circuit to measure voltage and the current. The filter housing has valves in the inlet, outlet, drain and vent nozzles so that the valves can be opened and closed during the service and the regeneration cycles.

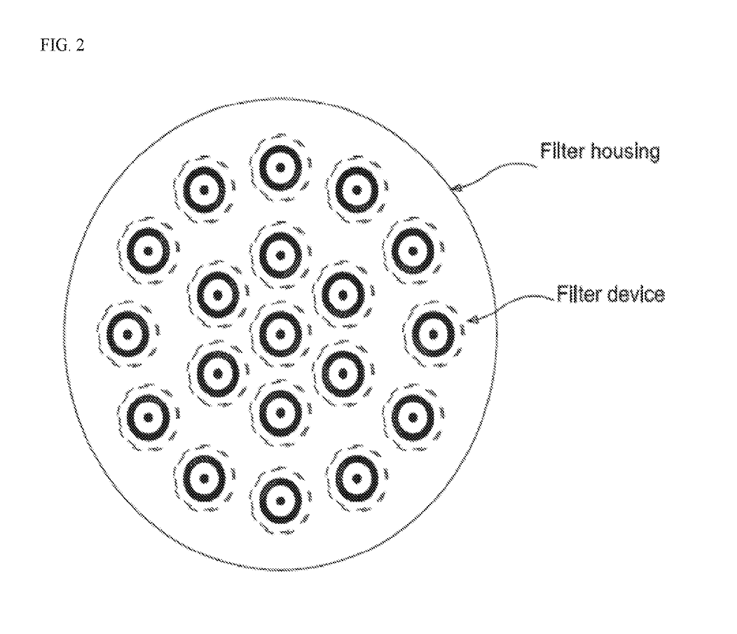

The filters are also designed for handling larger flows and the design can be scaled up by increasing the number of filters, In this case the filters operate in parallel. An embodiment of a filter with multiple elements is shown in FIG. 2. The filter has been designed to handle around 400 m³/hour of flow. One can use multiple of these filters to handle higher flows. For a flow of 1200 m³/hr, for example, typically there would be four filters and one of the filters can be taken for regeneration while the rest of the filters are performing filtration service.

In a preferred embodiment the filters are 40″ in length. In a further preferred embodiment one housing will have approximately one hundred cartridges. Each cartridge will have one anode and a cathode. The anode will be on the outside surrounding the cartridge, and the cathode will be inside the cartridge similar to the arrangement explained above. Similar designs can be created for filtration units for different flow rates.

FIG. 2 has housing 1, cartridge elements 2, cathode 4 and anode 3. In this case all the cathodes and anodes are connected together to create one pair of external connections with the DC supply. The DC supply box 5 can be mounted on the filter housing. Multiple filter units can be mounted on a skid, which can be piped with inlet, outlet and drain and vent headers combing all the filters. The filter housings are typically constructed of fiber reinforced plastic (FRP) material or alternatively rubber lined carbon steel or stainless steel material.

### EXAMPLES

I. Experiment 1

In this example, an electro-biofoulant removal filter was fabricated as shown in FIG. 1. A positively charged cartridge element 2 of size 2.5×40 inch was fitted in PVC housing 1. A perforated titanium anode plate 3 was assembled around cartridge element and stainless steel cathode rod 4 is fitted at center of cartridge element 2.

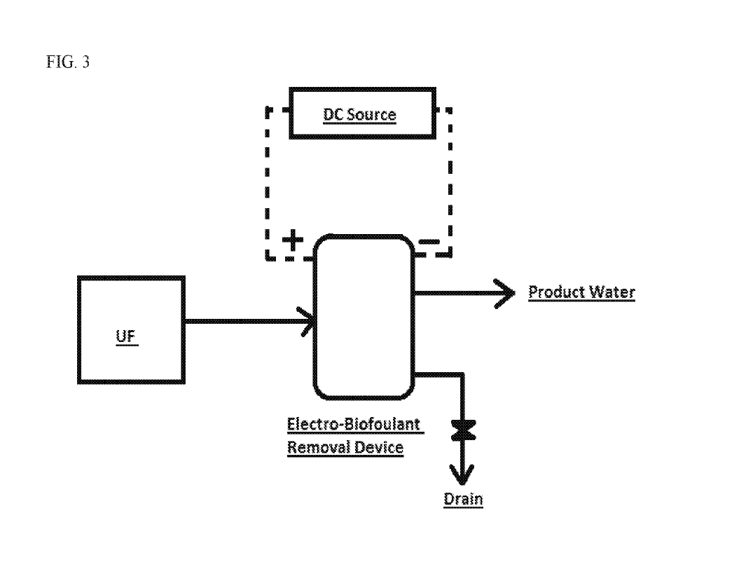

The filter was made leak proof and operated at a salt-water reverse osmosis SWRO plant site for 73 days as shown in FIG. 3. UF product water was fed into the device filter and operated with DC current. During service flow, the filter was operated by applying 10 to 20 mA DC current and inlet and outlet water turbidity were monitored. Daily one regeneration cycle for 1 to 2 minutes was performed on filter and filter regeneration was done by applying 30 mA current in reverse polarity and during regeneration cycle, reject water was drained through drain line and drain water turbidity was also recorded.

It was observed that during 73 days testing filter differential pressure (DP) remained constant and differential pressure regained after regeneration process. Filter operating data are summarized in Table 1. ORP of inlet and outlet water across filter were also monitored and observed nearly same values. No changes in ORP were observed. ORP values are summarized in Table 2.

TABLE 1
Electro-biofoulant Removal Filter Operating Data

| | Inlet | Outlet | Drain | Current | Current | | |
|---|---|---|---|---|---|---|---|
| Operating | turbidity, | turbidity, | turbidity, | during | during | DP before | DP after |
| Days | NTU | NTU | NTU | service, mA | regen, mA | regen, psi | regen, psi |
| 1 | 0.09 | 0.09 | 0.21 | 10 | 30 | 11 | 11 |
| 2 | 0.06 | 0.05 | 0.11 | 10 | 30 | 11 | 11 |
| 3 | 0.07 | 0.06 | 0.15 | 10 | 30 | 11 | 11 |
| 4 | 0.06 | 0.06 | 0.09 | 10 | 30 | 14.5 | 14.5 |
| 5 | 0.09 | 0.08 | 0.15 | 10 | 30 | 14.5 | 14.5 |
| 6 | 0.11 | 0.08 | 0.11 | 10 | 30 | 14.5 | 14.5 |
| 7 | 0.08 | 0.08 | 0.09 | 10 | 30 | 14.5 | 14.5 |
| 8 | 0.12 | 0.10 | 0.12 | 10 | 30 | 14.5 | 14.5 |
| 9 | 0.12 | 0.08 | 0.12 | 10 | 30 | 14.5 | 14.5 |
| 10 | 0.11 | 0.09 | 0.14 | 10 | 30 | 14.5 | 14.5 |
| 11 | 0.14 | 0.09 | 0.14 | 20 | 30 | 14.5 | 14.5 |
| 12 | 0.13 | 0.10 | 0.14 | 20 | 30 | 14.5 | 14.5 |
| 13 | 0.08 | 0.08 | 0.12 | 20 | 30 | 14.5 | 14.5 |
| 14 | 0.09 | 0.08 | 0.11 | 20 | 30 | 14.5 | 14.5 |
| 15 | 0.12 | 0.1 | 0.13 | 20 | 30 | 14.5 | 14.5 |
| 16 | 0.12 | 0.09 | 0.12 | 20 | 30 | 14.5 | 14.5 |
| 17 | 0.1 | 0.09 | 0.11 | 20 | 30 | 14.5 | 14.5 |
| 18 | 0.11 | 0.09 | 0.13 | 20 | 30 | 14.5 | 14.5 |
| 19 | 0.12 | 0.1 | 0.12 | 20 | 30 | 14.5 | 14.5 |
| 20 | 0.12 | 0.09 | 0.15 | 20 | 30 | 14.5 | 14.5 |
| 21 | 0.12 | 0.1 | 0.13 | 20 | 30 | 14.5 | 14.5 |
| 22 | 0.12 | 0.09 | 0.13 | 20 | 30 | 14.5 | 14.5 |
| 23 | 0.12 | 0.1 | 0.11 | 20 | 30 | 14.5 | 14.5 |
| 24 | 0.12 | 0.1 | 0.12 | 20 | 30 | 14.5 | 14.5 |
| 25 | 0.09 | 0.08 | 0.1 | 20 | 30 | 14.5 | 14.5 |
| 26 | 0.1 | 0.09 | 0.1 | 20 | 30 | 14.5 | 14.5 |
| 27 | 0.11 | 0.1 | 0.11 | 20 | 30 | 14.5 | 14.5 |
| 28 | 0.12 | 0.11 | 0.12 | 20 | 30 | 14.5 | 14.5 |
| 29 | 0.13 | 0.11 | 0.12 | 20 | 30 | 14.5 | 14.5 |
| 30 | 0.1 | 0.09 | 0.12 | 20 | 30 | 14.5 | 14.5 |
| 31 | 0.12 | 0.1 | 0.13 | 20 | 30 | 14.5 | 14.5 |
| 32 | 0.09 | 0.09 | 0.11 | 20 | 30 | 14.5 | 14.5 |
| 33 | 0.12 | 0.1 | 0.12 | 20 | 30 | 14.5 | 14.5 |
| 34 | 0.08 | 0.08 | 0.1 | 20 | 30 | 14.5 | 14.5 |
| 35 | 0.11 | 0.09 | 0.12 | 20 | 30 | 14.5 | 14.5 |
| 36 | 0.12 | 0.11 | 0.12 | 20 | 30 | 14.5 | 14.5 |
| 37 | 0.09 | 0.08 | 0.11 | 20 | 30 | 14.5 | 14.5 |
| 38 | 0.09 | 0.09 | 0.1 | 20 | 30 | 14.5 | 14.5 |
| 39 | 0.11 | 0.11 | 0.13 | 20 | 30 | 14.5 | 14.5 |
| 40 | 0.12 | 0.1 | 0.12 | 20 | 30 | 14.5 | 14.5 |
| 41 | 0.13 | 0.1 | 0.13 | 20 | 30 | 14.5 | 14.5 |
| 42 | 0.11 | 0.1 | 0.13 | 20 | 30 | 14.5 | 14.5 |
| 43 | 0.11 | 0.11 | 0.12 | 20 | 30 | 14.5 | 14.5 |
| 44 | 0.13 | 0.1 | 0.13 | 20 | 30 | 16 | 16 |
| 45 | 0.11 | 0.1 | 0.11 | 20 | 30 | 16 | 16 |
| 46 | 0.1 | 0.1 | 0.12 | 20 | 30 | 16 | 16 |
| 47 | 0.08 | 0.08 | 0.11 | 20 | 30 | 16 | 16 |
| 48 | 0.09 | 0.08 | 0.11 | 20 | 30 | 16 | 16 |
| 49 | 0.11 | 0.1 | 0.12 | 20 | 30 | 16 | 16 |
| 50 | 0.1 | 0.1 | 0.12 | 20 | 30 | 16 | 16 |
| 51 | 0.12 | 0.09 | 0.14 | 20 | 30 | 22 | 14.5 |
| 52 | 0.13 | 0.09 | 0.15 | 20 | 30 | 22 | 14.5 |
| 53 | 0.14 | 0.09 | 0.16 | 20 | 30 | 22 | 16 |
| 54 | 0.08 | 0.05 | 0.11 | 20 | 30 | 16 | 16 |
| 55 | 0.13 | 0.1 | 0.15 | 20 | 30 | 14.5 | 13 |
| 56 | 0.12 | 0.1 | 0.13 | 20 | 30 | 13 | 13 |
| 57 | 0.13 | 0.1 | 0.15 | 20 | 30 | 13 | 13 |
| 58 | 0.11 | 0.08 | 0.13 | 20 | 30 | 13 | 13 |
| 59 | 0.1 | 0.08 | 0.12 | 20 | 30 | 13 | 13 |
| 60 | 0.11 | 0.08 | 0.13 | 20 | 30 | 20 | 16 |
| 61 | 0.12 | 0.09 | 0.14 | 20 | 30 | 20 | 14.5 |
| 62 | 0.1 | 0.09 | 0.11 | 20 | 30 | 14.5 | 14.5 |
| 63 | 0.11 | 0.09 | 0.12 | 20 | 30 | 14.5 | 14.5 |
| 64 | 0.11 | 0.09 | 0.13 | 20 | 30 | 14.5 | 14.5 |
| 65 | 0.1 | 0.09 | 0.11 | 20 | 30 | 14.5 | 14.5 |
| 66 | 0.12 | 0.09 | 0.13 | 20 | 30 | 14.5 | 14.5 |
| 67 | 0.11 | 0.08 | 0.12 | 20 | 30 | 14.5 | 14.5 |
| 68 | 0.12 | 0.09 | 0.13 | 20 | 30 | 14.5 | 14.5 |
| 69 | 0.11 | 0.08 | 0.14 | 20 | 30 | 16 | 16 |
| 70 | 0.11 | 0.09 | 0.13 | 20 | 30 | 16 | 14.5 |
| 71 | 0.12 | 0.1 | 0.13 | 20 | 30 | 16 | 14.5 |
| 72 | 0.12 | 0.1 | 0.12 | 20 | 30 | 14.5 | 14.5 |
| 73 | 0.11 | 0.09 | 0.12 | 20 | 30 | 14.5 | 14.5 |

TABLE 2
ORP values across filter

| Operating | Inlet water | Outlet Water |
|---|---|---|
| Days | ORP, mV | ORP, mV |
| 62 | 251 | 250 |
| 65 | 200 | 190 |
| 69 | 221 | 207 |
| 72 | 226 | 225 |
| 73 | 239 | 236 |

II. Experiment 2

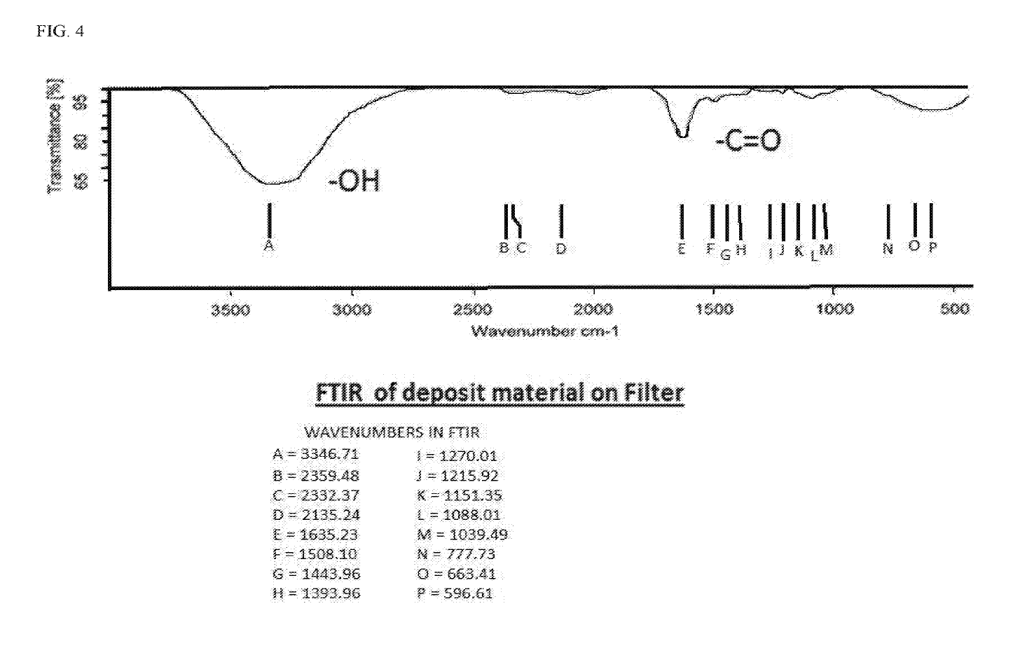

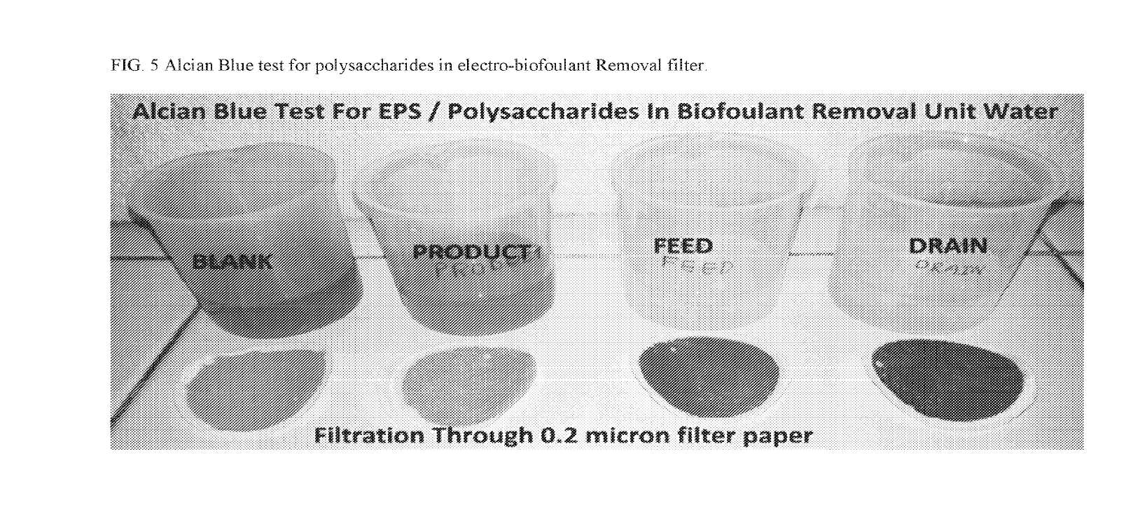

During operation of Experiment 1, water across filter was analyzed for microbiological analysis and bacterial count results are summarized in Table 3. Filter inlet, outlet and drain water was also checked for TEP (polysaccharides) content by Alcian blue test method and results shows 90% reduction of TEP in filtered outlet water (results shown in Table 4 and FIG. 5). FTIR analysis was also done on brownish deposit or coating on filter surface after operation of several days and results showed peaks of —OH (hydroxyl) and —COOH (carboxyl) groups, which are normally present in TEPs (see FIG. 4). These results indicate that invented device filter is effectively adsorbing and removing bacteria and TEPs from water.

TABLE 3
Microbiological Analysis of water samples across filter

| | | Pilot Filter | Pilot Filter |
|---|---|---|---|
| Parameters | Units | Drain | Product |
| Total Bacterial Count | CFU/ml | 1.8 × 10² | <10² |
| Total Coliforms | CFU/100 ml | 32 | NIL |
| Fecal Coliforms | CFU/100 ml | — | — |
| Enterococci | CFU/100 ml | — | — |
| Pseud0monas aeruginosa | CFU/250 ml | — | — |
| Total Chlorine | mg/L | 0 | 0 |
| Free Chlorine | mg/L | 0 | 0 |

TABLE 4
TEPs/polysaccharide content across filter water samples

| SAMPLE DESCRIPTION | UNIT | RESULTS |
|---|---|---|
| Filter Inlet water | PPM | 22.7 |
| Filtered Outlet water | PPM | 2.1 |
| Filter Drain water | PPM | 37.7 |
| Polysaccharides Removal | % | 90.75 |
| Efficiency | | |

We claim:

1. A filter system, comprising:
a housing having an interior and an exterior,
a filter cartridge on the interior of the housing, said filter cartridge comprising a cylindrical filter material, said filter material surrounding a cathode, and said filter material surrounded by an anode plate;
wherein the housing comprises an inlet, an outlet, a drain, and a vent.

2. The filter system of claim 1, wherein the filter system includes multiple filter cartridges depending on the design flow.

3. The filter system of claim 1, wherein the filter cartridge is at least 30″ in length.

4. The filter system of claim 1, wherein the filter cartridge is between 30″-40″ in length.

5. The filter system of claim 1, wherein the filter cartridge handles a wide range of flow rates up to 1000 m³/hour

6. The filter system of claim 1, wherein the cathode is a cylindrical rod.

7. The filter system of claim 1, wherein the filter material is positively charged.

8. The filter system of claim 1, wherein the filter material is negatively charged.

9. The filter system of claim 1, further comprising a power supply in a circuit with the cathode and the anode.

10. The filter system of claim 9, wherein the power supply is mounted on the housing.

11. The filter system of claim 1, wherein the housing is constructed of a material selected from the group consisting of fiber reinforced plastic, rubber-lined carbon steel, and stainless steel.

12. A filter system, comprising:
a housing having an interior and an exterior,
a plurality of filter cartridges on the interior of the housing, each of said filter cartridges comprising a cylindrical filter material, said filter material surrounding a cathode, and said filter material surrounded by an anode plate;
wherein the housing comprises an inlet, an outlet, a drain, and a vent.

13. The filter system of claim 12, wherein the filter system has a water flow rate capacity, and wherein the water flow rate capacity increases proportionately to the number of filter cartridges in the filter system.

14. The filter system of claim 12, wherein the filter cartridges operate in parallel.

15. A method for reducing biofouling on a reverse osmosis membrane, comprising:
treating water comprising biofoulants with an ultrafiltration membrane; and
after treating the water with an ultrafiltration membrane, treating the water with a charged filter system.

16. The method of claim 15, wherein said charged filter system comprises:
a housing having an interior and an exterior,
at least one filter cartridge on the interior of the housing, said filter cartridge comprising a cylindrical filter material, said filter material surrounding a cathode, and said filter material surrounded by an anode plate, wherein the housing comprises an inlet, an outlet, a drain, and a vent; and
a power supply in communication with the cathode and the anode.

17. The method of claim 15, wherein the water comprises an amount of polysaccharides, and wherein after treatment with the charged filter system the amount of polysaccharides is reduced.

18. The method of claim 15, wherein the water comprises an amount of bacteria, and wherein after treatment with the charged filter system the amount of bacteria is reduced without using any oxidants.

19. The method of claim 15, wherein there is no difference in oxidation reduction potential (ORP) value of water across the filter system.

20. The method of claim 15, further comprising regenerating at least one filter in the charged filter system in-situ by changing polarity of the charge and draining previously adsorbed material.
